(19) United States
(12) Patent Application Publication
(10) Pub. No.: US 2010/0106364 A1
(43) Pub. Date: Apr. 29, 2010

(54) INTER-VEHICLE COMMUNICATION SYSTEM AND METHOD FOR INDICATING SPEED AND DECELERATION

(75) Inventor: Atsushi Sagisaka, Susono-shi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi, Aichi-ken (JP)

(21) Appl. No.: 12/449,720

(22) PCT Filed: Feb. 26, 2008
(86) PCT No.: PCT/IB2008/000868

§ 371 Date: Aug. 24, 2009

(30) Foreign Application Priority Data
Feb. 26, 2007 (JP) 2007-045875

(51) Int. Cl. G06F 7/00

(52) U.S. Cl. 701/36

(57) ABSTRACT

A transmission cycle/output control portion (20) controls at least one of a transmission output of an inter-vehicle communication device (22) and a frequency of transmission from the inter-vehicle communication device (22) according to the speed of a host vehicle (100) detected by an in-vehicle sensor (12) so that the at least one of the transmission output and the frequency of transmission is set to a lower value as the speed becomes lower. In the case where the in-vehicle sensor (12) and a deceleration determination/gradient calculation portion (16) determine that the host vehicle (100) decelerates, the transmission cycle/output control portion (20) executes a control so that the at least one of the transmission output and the frequency of transmission is high as compared to the case where it is determined that the host vehicle (100) does not decelerate. Therefore, when the host vehicle (100) does not decelerate, communication traffic is reduced. When the host vehicle (100) decelerates, necessary communication is performed.

### BACKGROUND OF THE INVENTION

1. Field of the Invention

The invention relates to a vehicle communication system and a vehicle communication method. More specifically, the invention relates to a vehicle communication system that controls at least one of a transmission output and the frequency of transmission according to the speed of a host vehicle so that the at least one of the transmission output and the frequency of transmission is set to a lower value as the speed of the host vehicle becomes lower.

2. Description of the Related Art

When inter-vehicle communication is performed, and all vehicles transmit information at the same transmission output and with the same frequency of transmission, transmission traffic is extremely heavy. If a communication channel is designed taking into account the communication traffic in this case, a broad frequency band is required. This makes it difficult to provide the communication channel. Accordingly, technologies have been proposed to reduce the communication traffic while providing the high level of communication performance in the inter-vehicle communication.

For example, Japanese Patent Application Publication No 2000-90395 (JP-A-2000-90395) describes a technology in which a wireless communication device provided in a vehicle includes a microcomputer; the microcomputer receives data on the traveling state of the vehicle, for example, signals indicating an inter-vehicle distance, a current position, the orientation of the vehicle, and a traveling speed V, and a signal indicating whether a brake pedal is depressed; the microcomputer calculates a transmission cycle Td that becomes shorter as the traveling speed V becomes higher; and the wireless communication device transmits information regarding the vehicle, such as the traveling state, at the transmission cycle Td. In the technology described in the publication No. 2000-90395, when the vehicle travels at high speed, the wireless communication device transmits the information regarding the vehicle at a short transmission cycle. When the vehicle travels at low speed, the wireless communication device transmits the information regarding the vehicle at a long transmission cycle. Thus, a permissible number of vehicles (the number of vehicles that can enter a network without causing any problem) can be appropriately set, and further, the vehicle that travels at high speed can transmit information regarding the vehicle to the other vehicle so that the information is effectively used.

In the above-described technology, the current transmission cycle is changed according to the speed of the vehicle at a current time point. Therefore, for example, if a vehicle suddenly decelerates, the transmission cycle is increased according to the vehicle speed after the vehicle decelerates. Thus, although a following vehicle needs to quickly receive information for preventing a collision, from the vehicle that suddenly decelerates, the necessary information may not reach the following vehicle, or transmission of the information to the following vehicle may be delayed.

### SUMMARY OF THE INVENTION

The invention provides a vehicle communication system that performs necessary communication, and reduces communication traffic, when a vehicle decelerates.

A first aspect of the invention relates to a vehicle communication system that includes a transmission portion which is provided in a host vehicle, and which transmits information; a host vehicle speed detection portion that detects a speed of the host vehicle; a deceleration determination portion that determines whether the host vehicle decelerates or predicts whether the host vehicle will decelerate; and a transmission control portion that controls at least one of a transmission output of the transmission portion and a frequency of transmission from the transmission portion according to the speed of the host vehicle detected by the host vehicle speed detection portion so that the at least one of the transmission output and the frequency of transmission is set to a lower value as the speed of the host vehicle becomes lower. In the vehicle communication system, in a case where the deceleration determination portion determines that the host vehicle decelerates or predicts that the host vehicle will decelerate, the transmission control portion controls the at least one of the transmission output and the frequency of transmission so that the at least one of the transmission output and the frequency of transmission is high as compared to a case where the deceleration determination portion determines that the host vehicle does not decelerate or predicts that the host vehicle will not decelerate.

According to the first aspect, the transmission control portion controls the at least one of the transmission output of the transmission portion and the frequency of transmission from the transmission portion according to the speed of the vehicle detected by the host vehicle speed detection portion so that the at least one of the transmission output and the frequency of transmission is set to a lower value as the speed of the vehicle becomes lower. Therefore, it is possible to reduce communication traffic. Also, according to the first aspect, in the case where the deceleration determination portion determines that the host vehicle decelerates or predicts that the host vehicle will decelerate, the transmission control portion controls the at least one of the transmission output and the frequency of transmission so that the at least one of the transmission output and the frequency of transmission is high as compared to the case where the deceleration determination portion determines that the host vehicle does not decelerate or predicts that the host vehicle will not decelerate. Therefore, it is possible to perform necessary communication when the vehicle decelerates.

In this case, in the case where the deceleration determination portion determines that the host vehicle decelerates or predicts that the host vehicle will decelerate, the transmission control portion may maintain the at least one of the transmission output and the frequency of transmission at a value at a time point at which the deceleration determination portion determines that the host vehicle decelerates or predicts that the host vehicle will decelerate, during a predetermined period; and after the predetermined period elapses, the transmission control portion may control the at least one of the transmission output and the frequency of transmission according to the speed of the host vehicle detected by the host vehicle speed detection portion.

With this configuration, in the case where the deceleration determination portion determines that the host vehicle decelerates or predicts that the host vehicle will decelerate, the transmission control portion maintains the at least one of the transmission output and the frequency of transmission at the value at the time point at which the deceleration determination portion determines that the host vehicle decelerates or predicts that the host vehicle will decelerate, during the predetermined period. Therefore, when the vehicle decelerates, it is possible to perform necessary communication by maintaining at least one of the transmission output and the frequency of transmission at the value at the time point at which the deceleration determination portion determines that the host vehicle decelerates or predicts that the host vehicle will decelerate (hereinafter, may be referred to as “deceleration determination time point”). Also, after the predetermined period elapses, the transmission control portion controls the at least one of the transmission output and the frequency of transmission according to the speed of the host vehicle detected by the host vehicle speed detection portion. Therefore, it is possible to reduce the communication traffic after the predetermined period elapses.

In this case, the transmission control portion may increase the predetermined period during which the at least one of the transmission output and the frequency of transmission is maintained at the value at the time point, as the deceleration of the host vehicle detected by the host vehicle speed detection portion becomes larger.

According to this configuration, when the deceleration of the host vehicle is large, it is possible to perform necessary communication by increasing the period during which the at least one of the transmission output and the frequency of transmission is maintained at the value at the deceleration determination time point.

In the case where the deceleration determination portion determines that the host vehicle decelerates or predicts that the host vehicle will decelerate, the transmission control portion may control the at least one of the transmission output and the frequency of transmission so that the at least one of the transmission output and the frequency of transmission is higher than a value at a time point at which the deceleration determination portion determines that the host vehicle decelerates or predicts that the host vehicle will decelerate. Until the deceleration determination portion determines that the host vehicle finishes decelerating, the transmission control portion may control the at least one of the transmission output and the frequency of transmission so that the at least one of the transmission output and the frequency of transmission is high as compared to the case where the deceleration determination portion determines that the host vehicle does not decelerate or predicts that the host vehicle will not decelerate.

According to the configuration, it is possible to more reliably perform necessary communication when the vehicle decelerates.

The vehicle communication system may further include a following vehicle speed detection portion that detects deceleration of a following vehicle behind the host vehicle. In a case where the following vehicle speed detection portion determines that the following vehicle decelerates after the deceleration determination portion determines that the host vehicle decelerates or predicts that the host vehicle will decelerate, the transmission control portion may stop controlling the at least one of the transmission output and the frequency of transmission so that the at least one of the transmission output and the frequency of transmission is high as compared to the case where the deceleration determination portion determines that the host vehicle does not decelerate or predicts that the host vehicle will not decelerate, and may start to control the at least one of the transmission output and the frequency of transmission according to the speed of the host vehicle detected by the host vehicle speed detection portion.

According to this configuration, when the following vehicle decelerates, and communication need not be quickly performed, the at least one of the transmission output and the frequency of transmission is set to the value corresponding to the speed of the host vehicle. Therefore, it is possible to reduce the communication traffic.

In this case, the transmission control portion may maintain the at least one of the transmission output and the frequency of transmission at a value at a time point at which the deceleration determination portion determines that the host vehicle decelerates or predicts that the host vehicle will decelerate, after the deceleration determination portion determines that the host vehicle decelerates or predicts that the host vehicle will decelerate until the following vehicle speed detection portion determines that the following vehicle decelerates.

According to this configuration, it is possible to reduce the communication traffic after the following vehicle is reliably notified that the host vehicle decelerates.

A second aspect of the invention relates to a vehicle communication system that includes a transmission portion which is provided in a host vehicle, and which transmits information; a transmission control portion that controls at least one of a transmission output of the transmission portion and a frequency of transmission from the transmission portion; a host vehicle speed detection portion that detects a speed of the host vehicle; and a deceleration determination portion that determines whether the host vehicle decelerates or predicts whether the host vehicle will decelerate. In the vehicle communication system, in a case where the deceleration determination portion determines that the host vehicle decelerates or predicts that the host vehicle will decelerate, the transmission control portion controls the at least one of the transmission output and the frequency of transmission so that the at least one of the transmission output and the frequency of transmission is equal to a first value higher than a second value at a time point at which the deceleration determination portion determines that the host vehicle decelerates or predicts that the host vehicle will decelerate.

With this configuration, in the case where the deceleration determination portion determines that the host vehicle decelerates or predicts that the host vehicle will decelerate, the transmission control portion controls the at least one of the transmission output and the frequency of transmission so that the at least one of the transmission output and the frequency of transmission is equal to the first value higher than the second value at the time point at which the deceleration determination portion determines that the host vehicle decelerates or predicts that the host vehicle will decelerate. Therefore, it is possible to more reliably perform communication when the vehicle decelerates.

A third aspect of the invention relates to a vehicle communication system that includes a transmission portion which is provided in a host vehicle, and which transmits information; a host vehicle speed detection portion that detects a speed of the host vehicle; a deceleration determination portion that determines whether the host vehicle decelerates or predicts whether the host vehicle will decelerate; and a transmission control portion that executes a vehicle speed-dependent control that controls at least one of a transmission output of the transmission portion and a frequency of transmission from the transmission portion according to the speed of the host vehicle detected by the host vehicle speed detection portion so that the at least one of the transmission output and the frequency of transmission is set to a lower value as the speed of the host vehicle detected by the host vehicle speed detection portion becomes lower, and, in a case where the deceleration determination portion determines that the host vehicle decelerates or predicts that the host vehicle will decelerate, the transmission control portion delays start of the vehicle speed-dependent control.

In the third aspect, the transmission control portion also may execute a vehicle speed-independent control that sets the at least one of the transmission output and the frequency of transmission to a value that is equal to or higher than a value at a time point at which the deceleration determination portion determines that the host vehicle decelerates or predicts that the host vehicle will decelerate, independently of the speed of the host vehicle, during a period for which the start of the vehicle speed-dependent control is delayed.

According to the first, second and third aspects of the invention, it is possible to perform necessary communication, and to reduce the communication traffic when the vehicle decelerates.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a block diagram showing the configuration of a vehicle communication system according to a first embodiment;

FIG. 2 is a table showing the value of a transmission cycle corresponding to each vehicle speed according to the first embodiment;

FIG. 3 is a table showing the value of a delay period corresponding to deceleration according to the first embodiment;

FIG. 4 is a flowchart showing operation of a vehicle communication system according to the first embodiment;

FIG. 5 is a plan view showing a relation between a host vehicle and a following vehicle according to the first embodiment;

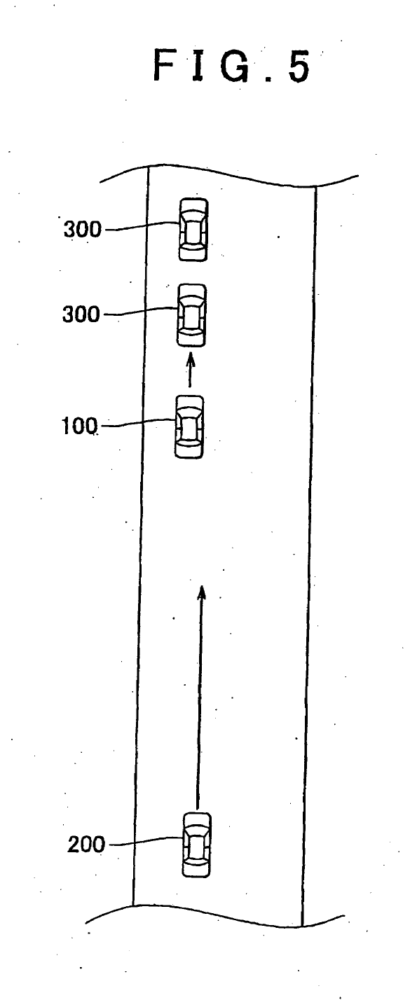

FIG. 6 is a graph showing a relation between the speed and deceleration of the host vehicle and the frequency of transmission or a transmission output;

FIG. 7 is a flowchart showing operation of a vehicle communication system according to a second embodiment;

FIG. 8 is a block diagram showing the configuration of a vehicle communication system according to a third embodiment;

FIG. 9 is a flowchart showing operation of a vehicle communication system according to a third embodiment;

FIG. 10 is a graph showing a relation between the speed and deceleration of the host vehicle and the frequency of transmission or the transmission output;

FIG. 11 is a flowchart showing operation of a vehicle communication system according to a fourth embodiment; and

FIG. 12 is a graph showing the speed and deceleration of the host vehicle and the frequency of transmission or the transmission output according to the fourth embodiment.

### DETAILED DESCRIPTION OF EMBODIMENTS

Hereinafter, a vehicle communication system according to each embodiment of the invention will be described with reference to the accompanying drawings.

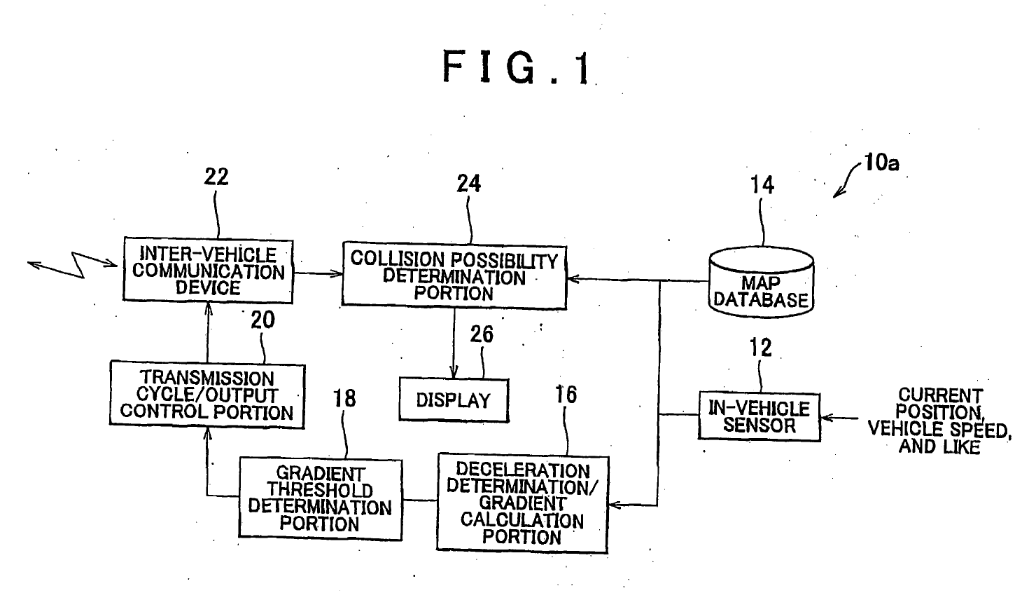

FIG. 1 is a block diagram showing the configuration of a vehicle communication system according to a first embodiment. The vehicle communication system according to the embodiment is configured using the hardware and software of a microcomputer, for example, an ECU (Electronic Control Unit). The vehicle communication system performs wireless inter-vehicle communication. Also, when there is a possibility that a host vehicle will collide with another vehicle, the vehicle communication system shows information regarding the collision to a driver.

As shown in FIG. 1, a vehicle communication system 10a according to the embodiment includes an in-vehicle sensor 12, a map database 14, a deceleration determination/gradient calculation portion 16, a gradient threshold determination portion 18, a transmission cycle/output control portion 20, an inter-vehicle communication device 22, a collision possibility determination portion 24, and a display 26.

More specifically, the in-vehicle sensor 12 includes a speedometer, a yaw rate sensor, and a GPS (Global Positioning System). The in-vehicle sensor 12 determines the speed, the yaw rate, the current position, and the like of the host vehicle.

The map database 14 is a database that stores map information for the GPS.

The deceleration determination/gradient calculation portion 16 determines whether the host vehicle decelerates, and calculates the deceleration gradient (deceleration), based on the speed and the like of the host vehicle determined by the in-vehicle sensor 12. The deceleration determination/gradient calculation portion 16 may predict the traveling state of the host vehicle in the future by referring to the map information stored in the map database 14, and then, determine whether there is a possibility that the host vehicle will decelerate, and calculate the deceleration gradient if there is a possibility that the host vehicle will decelerate.

The gradient threshold determination portion 18 determines whether the deceleration gradient of the host vehicle calculated by the deceleration determination/gradient calculation portion 16 is larger than a predetermined threshold value.

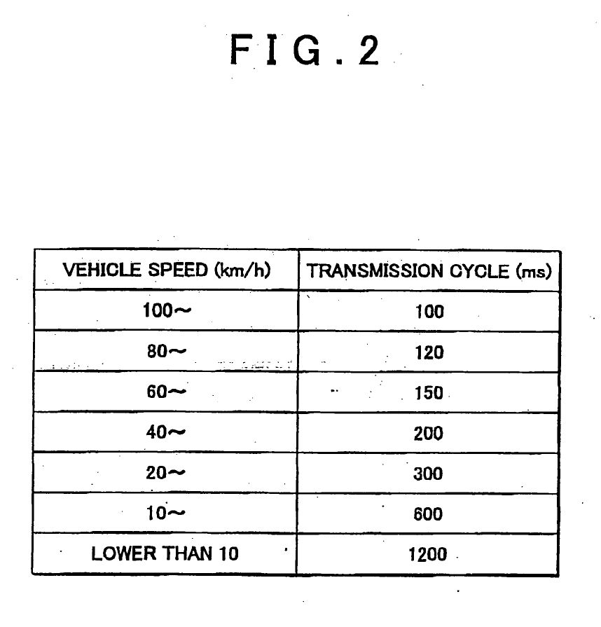

The transmission cycle/output control portion 20 controls a transmission cycle of the inter-vehicle communication device 22 (a frequency of transmission from the inter-vehicle communication device 22) and a transmission output of the inter-vehicle communication device 22. FIG. 2 is a table showing the transmission cycle corresponding to each vehicle speed according to the first embodiment. As shown in FIG. 2, in principle, the transmission cycle/output control portion 20 controls the inter-vehicle communication device 22 so that the transmission cycle becomes shorter and the frequency of transmission becomes higher as the vehicle speed becomes higher. In the other words, the transmission cycle/output control portion 20 controls the inter-vehicle communication device 22 so that the transmission cycle becomes longer and the frequency of transmission becomes lower as the vehicle speed becomes lower.

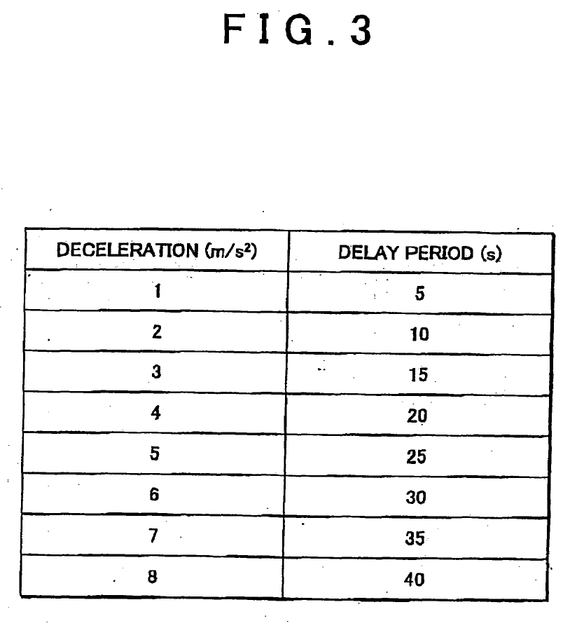

However, when the host vehicle decelerates, the transmission cycle/output control portion 20 selects a delay period set according to the deceleration as shown in FIG. 3, and controls the inter-vehicle communication device 22 to maintain the transmission cycle and the transmission output at values set before the host vehicle decelerates, from the start of the deceleration until the delay period elapses. This control will be described in detail later.

Referring to FIG. 1 again, the inter-vehicle communication device 22 is controlled by a control signal from the transmission cycle/output control portion 20. The inter-vehicle communication device 22 performs communication with another vehicle at the transmission cycle and the transmission output determined by the transmission cycle/output control portion 20. The inter-vehicle communication device 22 receives, from the other vehicle, the information such as the speed, deceleration, and the like of the other vehicle.

The collision possibility determination portion 24 determines whether there is a possibility that the host vehicle will collide with the other vehicle, by referring to the information regarding the other vehicle received by the inter-vehicle communication device 22, and the map information stored in the map database 14.

For example, the display 26 is a monitor of a navigation system. The display 26 shows the driver the possibility of collision with the other vehicle determined by the collision possibility determination portion 24.

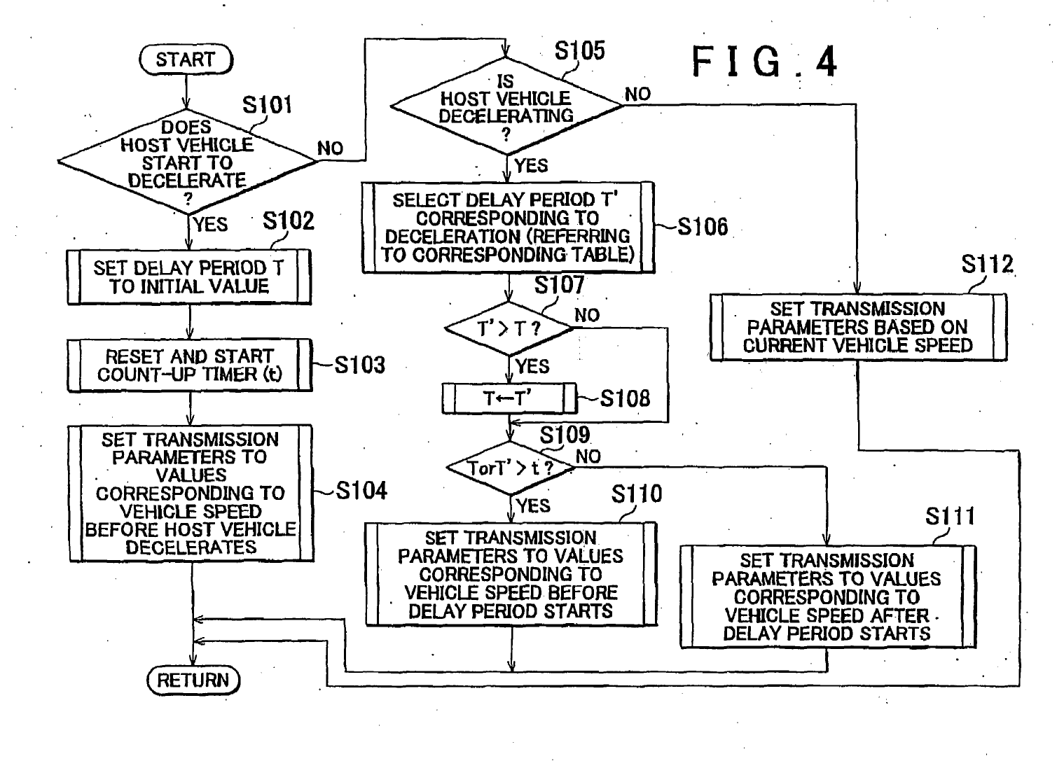

Next, operation of the vehicle communication system 10a according to the embodiment will be described. FIG. 4 is a flowchart showing the operation of the vehicle communication system 10a according to the first embodiment. In the vehicle communication system 10a according to the embodiment, the control described below is repeatedly executed at predetermined timings during the period from when a power source in the vehicle is turned on until when the power source is turned off. The following description relates to the control of the communication between a host vehicle 100 and a following vehicle 200 when a preceding vehicle 300 ahead of the host vehicle 100 decelerates to avoid a traffic jam or an accident, and accordingly, the host vehicle 100 also decelerates.

When the in-vehicle sensor 12 and the deceleration determination/gradient calculation portion 16 determine that the host vehicle 100 starts to decelerate (S101), the transmission cycle/output control portion 20 sets the delay period T to an initial value (S102). The initial value in this case may be set to any value in a range of 1 to 60 seconds. The transmission cycle/output control portion 20 resets a count-up timer “t” to zero, and then, starts the count-up timer “t” (S103). The transmission cycle/output control portion 20 sets the transmission parameters (the transmission cycle and the transmission output) to values corresponding to the vehicle speed before the host vehicle 100 decelerates, by referring to the values of the transmission cycle and the transmission output corresponding to each vehicle speed as shown in FIG. 2 (S104). Although both of the transmission cycle and the transmission output are controlled in this embodiment, only one of the transmission cycle and the transmission output may be controlled.

When the in-vehicle sensor 12 and the deceleration determination/gradient calculation portion 16 determine that the host vehicle 100 has already started to decelerate, and is decelerating (S101, S105), the transmission cycle/output control portion 20 selects a delay period T′ corresponding to the deceleration, by referring to the deceleration determined by the gradient threshold determination portion 18, and the value of the delay period corresponding to each deceleration as shown in FIG. 3 (S106). When the selected delay period T′ is longer than the delay period T that is the initial value, the transmission cycle/output control portion 20 sets the delay period T′ to the delay period T that is the initial value (S107, S108). When the selected delay period T′ is equal to or shorter than the delay period T (initial value), the transmission cycle/output control portion 20 maintains the selected delay period T′ (S107, S109). By performing this operation, the transmission cycle/output control portion 20 can set the delay period to the value corresponding to the deceleration.

When the value of the count-up timer “t” does not reach the delay period T or T′, the transmission cycle/output control portion 20 sets the transmission parameters to values corresponding to the vehicle speed before the delay period starts, that is, the transmission cycle/output control portion 20 maintains the transmission cycle of the inter-vehicle transmission device 22 and the transmission output of the inter-vehicle transmission device 22 at the values corresponding to the vehicle speed before the delay period starts, for example, the vehicle speed at a time point earlier than a current time point by the count-up timer “t” (S109, S110). After the value of the count-up timer “t” reaches the delay period T or T′, the transmission cycle/output control portion 20 sets the transmission parameters to values corresponding to the vehicle speed at a time point earlier than a current time point by the delay period T or T′, that is, the transmission cycle/output control portion 20 increases the transmission cycle, and decreases the transmission output (S109, S111).

When the in-vehicle sensor 12 and the deceleration determination/gradient calculation portion 16 determine that the host vehicle 100 has already finished decelerating (S101, S105), the transmission cycle/output control portion 20 sets the transmission parameters (the transmission cycle and the transmission output) by referring to the values of the transmission cycle and the transmission output corresponding to each vehicle speed as shown in FIG. 2 (S112).

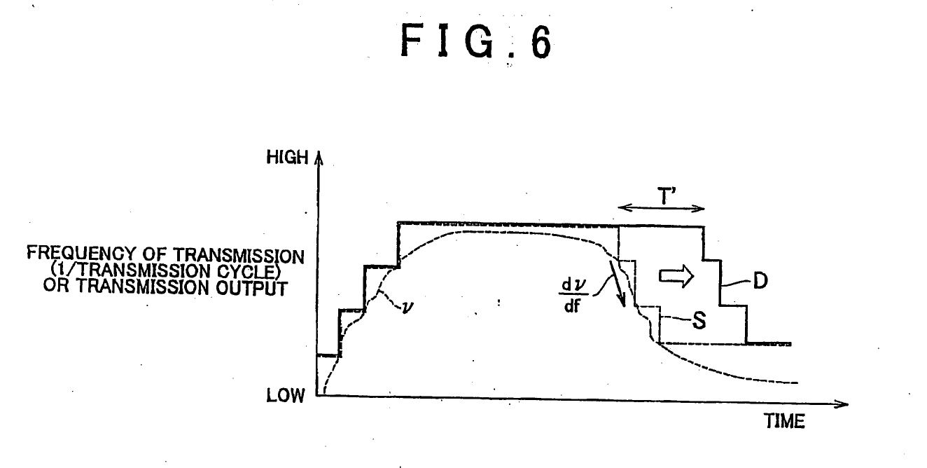

That is, in the system that controls a frequency of transmission (=1/transmission cycle) or transmission output S according to a vehicle speed v, by performing the above-described operation, the frequency of transmission or transmission output is set in the following manner as shown in FIG. 6. When the host vehicle decelerates, the frequency of transmission (=1/transmission cycle) or transmission output is maintained at a value D corresponding to the vehicle speed before the host vehicle decelerates, during the delay period T or T′. The delay period T′ is changed according to a deceleration gradient dv/dt.

According to the embodiment, when it is not determined that the host vehicle decreases, the transmission cycle/output control portion 20 controls the transmission output of the inter-vehicle device 22 and the frequency of transmission from the inter-vehicle device 22 according to the speed of the host vehicle 100 detected by the in-vehicle sensor 12 so that the transmission output and the frequency of transmission are set to lower values as the vehicle speed becomes lower. Therefore, it is possible to reduce communication traffic. Also, according to the embodiment, in the case where the in-vehicle sensor 12 and the deceleration determination/gradient calculation portion 16 determine that the host vehicle 100 decelerates, the transmission cycle/output control portion 20 controls the transmission output of the inter-vehicle communication device 22 and the frequency of transmission from the inter-vehicle communication device 22 so that the transmission output and the frequency of transmission are high as compared to the case where the in-vehicle sensor 12 and the deceleration determination/gradient calculation portion 16 determine that the host vehicle 100 does not decelerate. Therefore, it is possible to reliably perform necessary communication when the host vehicle 100 decelerates.

Also, according to the embodiment, when the in-vehicle sensor 12 and the deceleration determination/gradient calculation portion 16 determine that the host vehicle 100 decelerate, the transmission cycle/output control portion 20 maintains the transmission output of the inter-vehicle communication device 22 and the frequency of transmission from the inter-vehicle communication device 22 at the values at the time point at which it is determined that the host vehicle 100 decelerate (hereinafter, may be referred to as “deceleration determination time point”), during the delay period T or T′. Therefore, when the host vehicle 100 decelerates, it is possible to reliably perform transmission at the transmission output at the deceleration determination time point, and with the frequency of transmission at the deceleration determination time point. Also, in the case where the host vehicle 100 is still decelerating after the delay period T or T′ elapses, the transmission cycle/output control portion 20 sets the transmission output of the inter-vehicle communication device 22 and the frequency of transmission from the inter-vehicle communication device 22 to the values corresponding to the vehicle speed at the time point earlier than the current time point by the delay period T or T′. Then, when the host vehicle 100 finishes decelerating, the transmission cycle/output control portion 20 sets the transmission output and the frequency of transmission to the values corresponding to the vehicle speed at the time point at which the host vehicle 100 finishes decelerating. In the case where the host vehicle 100 has finished decelerating when the delay period T or T′ elapses, the transmission cycle/output control portion 20 controls the transmission output of the inter-vehicle communication device 22 and the frequency of transmission from the inter-vehicle communication device 22 according to the speed of the host vehicle 100 detected by the in-vehicle sensor 12. Therefore, after the delay period T or T′ elapses, it is possible to reduce the communication traffic.

Further, the transmission cycle/output control portion 20 increases the delay period T′ during which the transmission output of the inter-vehicle communication device 22 and the frequency of transmission from the inter-vehicle communication device 22 are maintained at the values at the deceleration determination time point, as the deceleration of the host vehicle 100 detected by the in-vehicle sensor 12 and the deceleration determination/gradient calculation portion 16 becomes larger. Therefore, when the deceleration of the host vehicle 100 is large, it is possible to reliably perform necessary communication by increasing the period during which the transmission output and the frequency of transmission are maintained at the values at the deceleration determination time point.

That is, when the transmission cycle of a low-speed vehicle is long, for example, if a following vehicle behind the low-speed vehicle enters a communication area immediately after the low-speed vehicle transmits data, the following vehicle receives the data after the transmission cycle time of the low-speed vehicle elapses. Also, when the transmission output of the low-speed vehicle is low, the area where the data reaches is reduced. Therefore, for example, if a following vehicle behind the low-speed vehicle travels at higher speed than the speed of the low-speed vehicle, and approaches the low-speed vehicle, the time point at which the data reaches the following vehicle is delayed due to the reduction of the area, although a driver in the following vehicle needs to be alerted. Accordingly, in the embodiment, when the host vehicle 100 suddenly decelerates or suddenly stops, the delay period, during which information can be quickly transmitted to the following vehicle 200, is provided. Thus, the following vehicle 200, which is present within a distance corresponding to the delay period, can determine that the host vehicle 100 suddenly decelerates or suddenly stops.

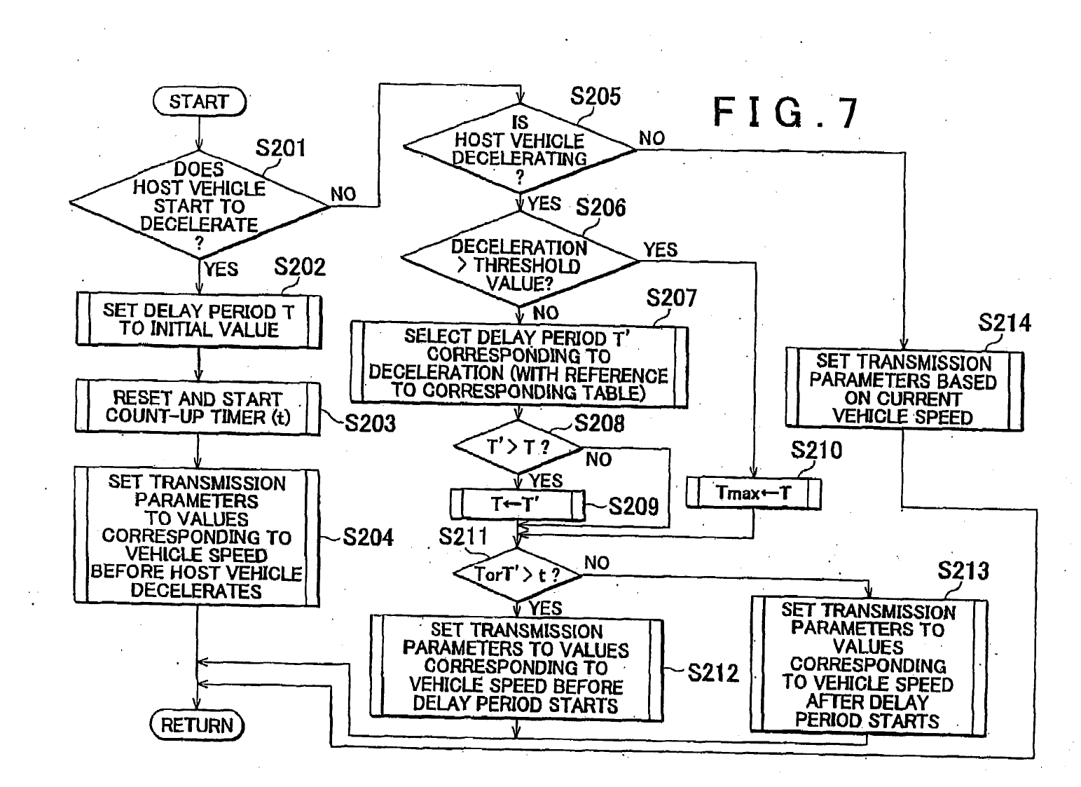

Hereinafter, a second embodiment of the invention will be described. FIG. 7 is a flowchart showing the operation of the vehicle communication system according to the second embodiment. As shown in FIG. 7, in the second embodiment, when the in-vehicle sensor 12 and the deceleration determination/gradient calculation portion 16 determine that the host vehicle 100 has already started to decelerate (S201, S205), the gradient threshold determination portion 18 determines whether the detected deceleration is larger than a predetermined threshold value (S206). The second embodiment differs from the first embodiment in that when the deceleration is larger than the predetermined threshold value, the transmission cycle/output control portion 20 sets the delay period T, which is the initial value, to a delay period Tmax that is an upper limit value.

According to the second embodiment, when the deceleration of the host vehicle 100 is larger than the predetermined threshold value, that is, the deceleration is large, it is possible to prevent an excessive increase in the communication traffic due to an excessive increase in the delay period, because the transmission cycle/output control portion 20 sets the delay period T to the delay period Tmax that is the upper limit value.

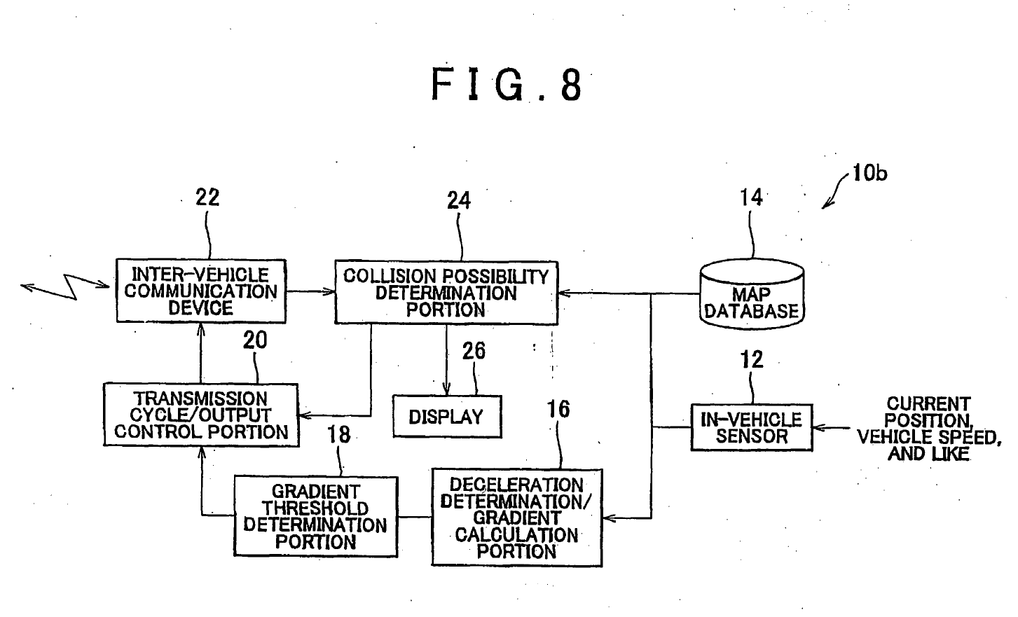

Hereinafter, a third embodiment of the invention will be described. FIG. 8 is a block diagram showing the configuration of a vehicle communication system according to a third embodiment. The third embodiment differs from the first embodiment in that a signal path from the collision possibility determination portion 24 to the transmission cycle/output control portion 20 is provided, in a vehicle communication system 10b according to the third embodiment, as shown in FIG. 8. The collision possibility determination portion 24 determines whether the following vehicle 200 decelerates, using information obtained from the in-vehicle sensor 12 and the map database 14. When the transmission cycle/output control portion 20 receives, from the collision possibility determination portion 24, the information as to whether the following vehicle 200 decelerates, the transmission cycle/output control portion 20 performs the operation described below.

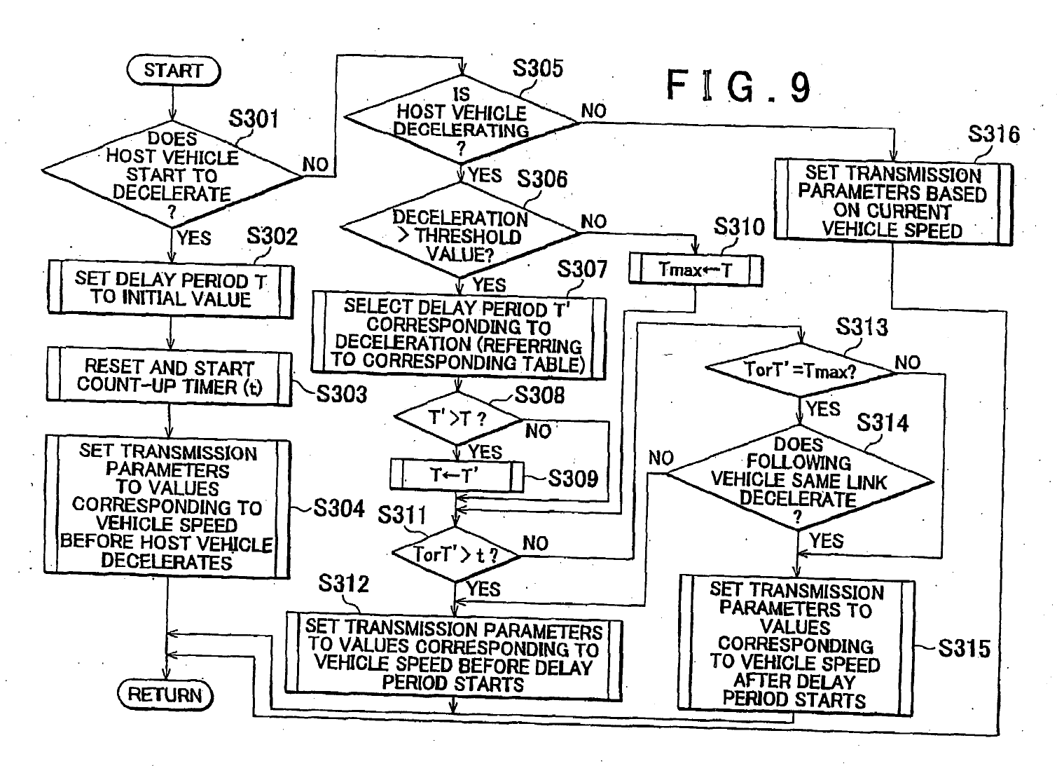

FIG. 9 is a flowchart showing the operation of the vehicle communication system according to the third embodiment. As shown in FIG. 9, in the case where the value of the count-up timer “t” reaches the delay period T or T′ (S311), the delay period T′ is equal to the delay period Tmax that is the upper limit value (S313), and the collision possibility determination portion 24 notifies the transmission cycle/output control portion 20 that the following vehicle 200 decelerates (S314), the transmission cycle/output control portion 20 sets the transmission parameters to values corresponding to the vehicle speed after the delay period starts, that is, the transmission cycle/output control portion 20 increases the transmission cycle of the inter-vehicle communication device 22, and decreases the transmission output of the inter-vehicle communication device 22 (S315). In the case where the delay period T′ is equal to the delay period Tmax that is the upper limit value (S313), and the collision possibility determination portion 24 does not notify the transmission cycle/output control portion 20 that the following vehicle 200 decelerates (S314), the transmission cycle/output control portion 20 sets the transmission parameters to values corresponding to the vehicle speed before the delay period starts (S312). When the delay period T′ is not equal to the delay period Tmax that is the upper limit value, the transmission cycle/output control portion 20 sets the transmission parameters to the values corresponding to the vehicle speed after the delay period starts, that is, the transmission cycle/output control portion 20 increases the transmission cycle, and decreases the transmission output (S315).

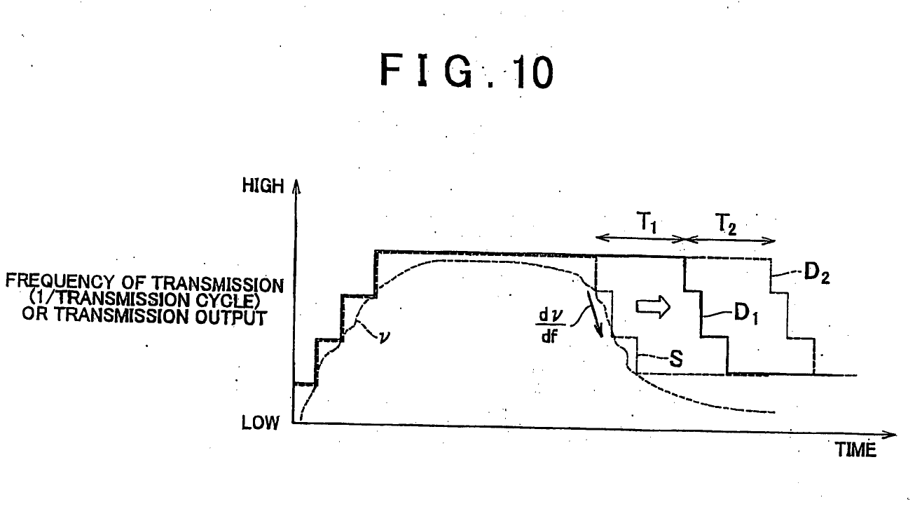

That is, in the system that controls the frequency of transmission (=1/transmission cycle) or transmission output S according to the vehicle speed v, by performing the above-described operation, the frequency of transmission (=1/transmission cycle) or transmission output is set in the following manner as shown in FIG. 10. The frequency of transmission (=1/transmission cycle) or transmission output is maintained at a value corresponding to the vehicle speed before the host vehicle 100 decelerates during a delay period T₁ as shown by the solid line D₁. If it is determined that the following vehicle 200, which is present within the same link, does not decelerate when the delay period T₁ has elapsed, the frequency of transmission (=1/transmission cycle) or transmission output is set to the value corresponding to the vehicle speed before the host vehicle 100 decelerates until it is determined that the following vehicle 200 decelerates after T₂ second(s), and then, the frequency of transmission (=1/transmission cycle) or transmission output is set to a value corresponding to the vehicle speed after the host vehicle 100 starts to decelerate as shown by the dashed line D₂.

According to the embodiment, when the inter-vehicle communication device 22 determines that the following vehicle 200 decelerates, the transmission cycle/output control portion 20 sets the transmission output of the inter-vehicle communication device 22 and the frequency of transmission from the inter-vehicle communication device 22 to the values corresponding to the vehicle speed of the host vehicle 100 detected by the in-vehicle sensor 12 at the time point earlier than the current time point by the delay period T₁. Therefore, when the following vehicle 200 decelerates, and therefore, the host vehicle 100 need not quickly communicate with the following vehicle 200, the transmission output and the frequency of transmission are set to the values corresponding to the actual speed of the host vehicle 100 during the delay period T₁. Therefore, it is possible to reduce the communication traffic. That is, in the embodiment, when the host vehicle 100 suddenly stops due to sudden brake, collision, or the like, the delay period, during which the following vehicle 200 can effectively receive information, is extended until it is determined that the following vehicle 200 decelerates. Therefore, it is possible to reliably notify the following vehicle 200 that the host vehicle 100 decelerates or stops. This contributes to safety.

Particularly, according to the embodiment, the transmission cycle/output control portion 20 maintains the transmission output of the inter-vehicle communication device 22 and the frequency of transmission from the inter-vehicle communication device 22 at the values at the time point at which it is determined that the host vehicle 100 decelerates, after the in-vehicle sensor 12 and the deceleration determination/gradient calculation portion 16 determine that the host vehicle 100 decelerates until the inter-vehicle communication device 22 determines that the following vehicle 200 decelerates. Therefore, it is possible to reduce the communication traffic after the following vehicle 200 is reliably notified that the host vehicle 100 decelerates or stops.

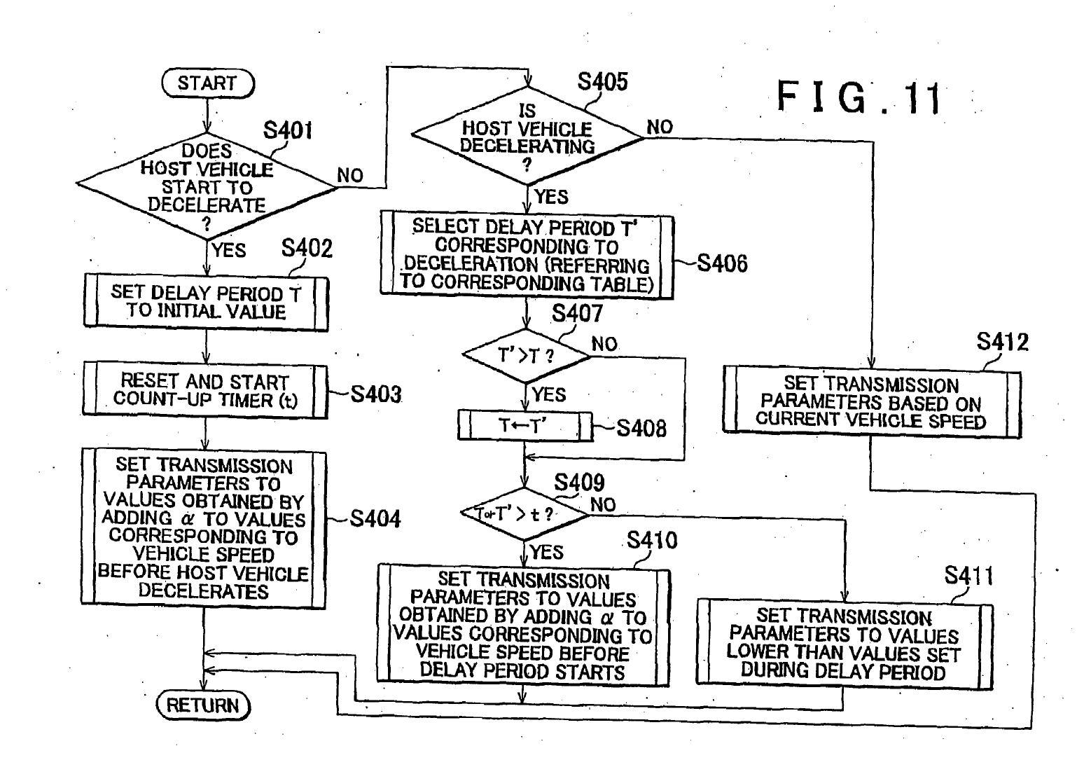

Hereinafter, a fourth embodiment of the invention will be described. FIG. 11 is a flowchart showing the operation of a vehicle communication system according to a fourth embodiment of the invention. As shown in FIG. 11, in the fourth embodiment, when the in-vehicle sensor 12 and the deceleration determination/gradient calculation portion 16 determine that the host vehicle 100 starts to decelerate (S401), the transmission cycle/output control portion 20 sets the transmission parameters (the transmission cycle (the frequency of transmission) and the transmission output) so that the transmission cycle is shorter than a value corresponding to the vehicle speed before the host vehicle 100 decelerates in FIG. 2, and the transmission output is higher than a value corresponding to the vehicle speed before the host vehicle 100 decelerates (S404).

When the in-vehicle sensor 12 and the deceleration determination/gradient calculation portion 16 determine that the host vehicle 100 is decelerating (S401, S405), and the value of the count-up timer “t” does not reach the delay period T or T′, the transmission cycle/output control portion 20 sets the transmission parameters to values higher than values corresponding to the vehicle speed before the delay period starts, that is, the transmission cycle/output control portion 20 increases the frequency of transmission from the inter-vehicle communication device 22 (i.e., decreases the transmission cycle), and increases the transmission output of the inter-vehicle communication device 22 (S409, S410). When the value of the count-up timer “t” reaches the delay period T or T′, the transmission cycle/output control portion 20 sets the transmission parameters to values that are higher, by α, than values corresponding to the vehicle speed at a time point earlier than a current time point by the delay period T or T′ (i.e., the transmission cycle/output control portion 20 sets the transmission parameters to values lower than values set during the delay period T or T′), that is, the transmission cycle/output control portion 20 decreases the frequency of transmission from the inter-vehicle communication device 22 (i.e., increases the transmission cycle), and decreases the transmission output of the inter-vehicle communication device 22 (S409, S411).

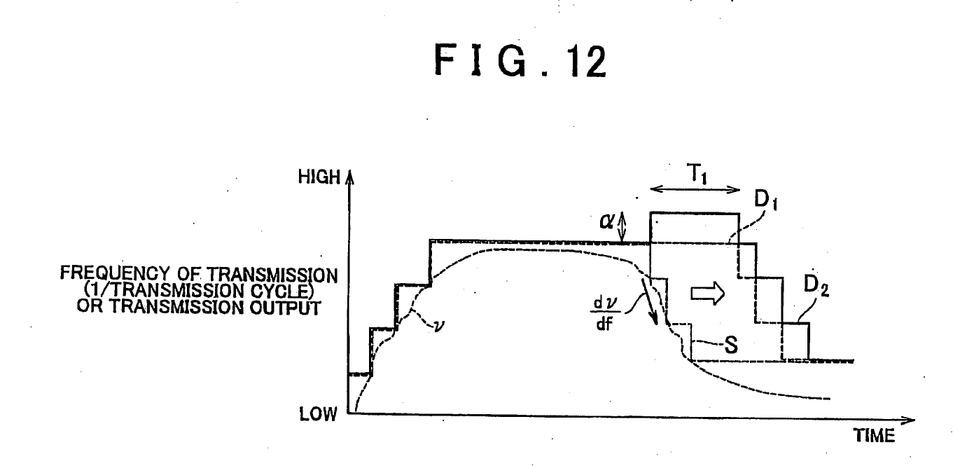

That is, in the system that controls the frequency of transmission (=1/transmission cycle) or transmission output S according to the vehicle speed v, by performing the above-described operation, the transmission cycle or transmission output S is set in the following manner as shown in FIG. 12. When the host vehicle 100 decelerates, the frequency of transmission (=1/transmission cycle) or transmission output is maintained at a value D₂ that is higher than the value D₁ at which the frequency of transmission or transmission output is maintained in the first embodiment, during the delay period T₁. The delay period T₁ is changed according to the deceleration gradient dv/dt.

According to the fourth embodiment, in the case where the in-vehicle sensor 12 and the deceleration determination/gradient calculation portion 16 determine that the host vehicle 100 decelerates, the transmission cycle/output control portion 20 controls the transmission output of the inter-vehicle transmission device 22 and the frequency of transmission from the inter-vehicle transmission device 22 so that the transmission output and the frequency of transmission are higher than the values at the deceleration determination time point during the delay period. Until the in-vehicle sensor 12 and the deceleration determination/gradient calculation portion 16 determine that the host vehicle 100 finishes decelerating, the transmission cycle/output control portion 20 controls the transmission output of the inter-vehicle transmission device 22 and the frequency of transmission from the inter-vehicle transmission device 22 so that the transmission output and the frequency of transmission are high as compared to the case where the in-vehicle sensor 12 and the deceleration determination/gradient calculation portion 16 determines that the host vehicle 100 does not decelerate. Therefore, when the host vehicle 100 decelerates, it is possible to reliably perform communication.

In the above-described embodiment, in the case where the deceleration determination/gradient calculation portion 16 determines that the host vehicle decelerates, the transmission output and the frequency of transmission are maintained at the relatively high values. However, the invention is not limited to this configuration. In the case where the deceleration determination/gradient calculation portion 16 predicts the traveling state of the host vehicle in the future by referring to the map information stored in the map database 14, and determines that there is a possibility that the host vehicle will decelerate, at least one of the transmission output and the frequency of transmission may be maintained at the relatively high value.

In the above-described embodiment, in the case where it is determined that the host vehicle decelerates, the transmission output and the frequency of transmission are maintained at the values at the deceleration determination time point or the values higher than the values at the deceleration determination time point. However, the invention is not limited to the configuration. In the case where it is determined that the host vehicle decelerates, at least one of the transmission output and the frequency of transmission may be set according to the speed of the host vehicle. In this case, the at least one of the transmission output and the frequency of transmission is decreased according to a decrease in the speed of the host vehicle at a low rate as compared to the case where it is determined that the host vehicle does not decelerate (for example, refer to the table showing a rate at which the set value of the transmission cycle is decreased according to a decrease in the vehicle speed in FIG. 2). In other words, the at least one of the transmission output and the frequency of transmission is decreased according to a decrease in the speed of the host vehicle in a manner such that the at least one of the transmission output and the frequency of transmission is higher than a value set according to the speed of the host vehicle in the case where it is determined that the host vehicle does not decelerate (refer to FIG. 2). In this manner, it is possible to reliably perform communication when the host vehicle decelerates. Also, in the above-described embodiment, in the case where it is determined that the host vehicle decelerates, the transmission output and the frequency of transmission are maintained at the values at the deceleration determination time point or the values higher than the values at the deceleration determination time point. However, the invention is not limited to the configuration. In the case where it is determined that the host vehicle decelerates, at least one of the transmission output and the frequency of transmission may be maintained at a value lower than the value at the deceleration determination time point. In this case, the at least one of the transmission output and the frequency of transmission is maintained at a value higher than the value set according to the speed of the host vehicle. In this manner, the purpose of the invention is achieved.

Although the embodiments of the invention have been described, the invention is not limited to the above-described embodiments. Various modifications may be made to the above-described embodiments.

1. A vehicle communication system comprising:
a transmission portion which is provided in a host vehicle, and which transmits information;
a host vehicle speed detection portion that detects a speed of the host vehicle; a deceleration determination portion that determines whether the host vehicle decelerates or predicts whether the host vehicle will decelerate; and
a transmission control portion that controls at least one of a transmission output of the transmission portion and a frequency of transmission from the transmission portion according to the speed of the host vehicle detected by the host vehicle speed detection portion so that the at least one of the transmission output and the frequency of transmission is set to a lower value as the speed of the host vehicle becomes lower,
wherein in a case where the deceleration determination portion determines that the host vehicle decelerates or predicts that the host vehicle will decelerate, the transmission control portion controls the at least one of the transmission output and the frequency of transmission so that the at least one of the transmission output and the frequency of transmission is high as compared to a case where the deceleration determination portion determines that the host vehicle does not decelerate or predicts that the host vehicle will not decelerate.

2. The vehicle communication system according to claim 1, wherein:
in the case where the deceleration determination portion determines that the host vehicle decelerates or predicts that the host vehicle will decelerate, the transmission control portion maintains the at least one of the transmission output and the frequency of transmission at a value at a time point at which the deceleration determination portion determines that the host vehicle decelerates or predicts that the host vehicle will decelerate, during a predetermined period; and
after the predetermined period elapses, the transmission control portion controls the at least one of the transmission output and the frequency of transmission according to the speed of the host vehicle detected by the host vehicle speed detection portion.

3. The vehicle communication system according to claim 2, wherein:
the vehicle communication system further includes a host vehicle deceleration detection portion that detects deceleration of the host vehicle; and
the transmission control portion increases the predetermined period during which the at least one of the transmission output and the frequency of transmission is maintained at the value at the time point, as the deceleration of the host vehicle detected by the host vehicle deceleration detection portion becomes larger.

4. The vehicle communication system according to claim 3, wherein
when the deceleration of the host vehicle detected by the host vehicle deceleration detection portion is larger than a predetermined threshold value, the transmission control portion sets the predetermined period to a constant value, independently of the deceleration of the host vehicle.

5. The vehicle communication system according to claim 1, wherein:
in the case where the deceleration determination portion determines that the host vehicle decelerates or predicts that the host vehicle will decelerate, the transmission control portion controls the at least one of the transmission output and the frequency of transmission so that the at least one of the transmission output and the frequency of transmission is higher than a value at a time point at which the deceleration determination portion determines that the host vehicle decelerates or predicts that the host vehicle will decelerate, and
until the deceleration determination portion determines that the host vehicle finishes decelerating, the transmission control portion controls the at least one of the transmission output and the frequency of transmission so that the at least one of the transmission output and the frequency of transmission is high as compared to the case where the deceleration determination portion determines that the host vehicle does not decelerate or predicts that the host vehicle will not decelerate.

6. The vehicle communication system according to claim 1, further comprising:
a following vehicle speed detection portion that determines whether a following vehicle behind the host vehicle decelerates,
wherein:
in a case where the following vehicle speed detection portion determines that the following vehicle decelerates after the deceleration determination portion determines that the host vehicle decelerates or predicts that the host vehicle will decelerate, the transmission control portion stops controlling the at least one of the transmission output and the frequency of transmission so that the at least one of the transmission output and the frequency of transmission is high as compared to the case where the deceleration determination portion determines that the host vehicle does not decelerate or predicts that the host vehicle will not decelerate, and starts to control the at least one of the transmission output and the frequency of transmission according to the speed of the host vehicle detected by the host vehicle speed detection portion.

7. The vehicle communication system according to claim 6, wherein:
the transmission control portion maintains the at least one of the transmission output and the frequency of transmission at a value at a time point at which the deceleration determination portion determines that the host vehicle decelerates or predicts that the host vehicle will decelerate, after the deceleration determination portion determines that the host vehicle decelerates or predicts that the host vehicle will decelerate until the following vehicle speed detection portion determines that the following vehicle decelerates.

8. The vehicle communication system according to claim 1, wherein:
in the case where the deceleration determination portion determines that the host vehicle decelerates or predicts that the host vehicle will decelerate, the transmission control portion maintains the at least one of the transmission output and the frequency of transmission at a value at a time point at which the deceleration determination portion determines that the host vehicle decelerates or predicts that the host vehicle will decelerate.

9. The vehicle communication system according to claim 1, wherein
in the case where the deceleration determination portion determines that the host vehicle decelerates or predicts that the host vehicle will decelerate, the transmission control portion controls the at least one of the transmission output and the frequency of transmission so that the at least one of the transmission output and the frequency of transmission is higher than a value at a time point at which the deceleration determination portion determines that the host vehicle decelerates or predicts that the host vehicle will decelerate.

10. A vehicle communication system comprising:
a transmission portion which is provided in a host vehicle, and which transmits information;
a transmission control portion that controls at least one of a transmission output of the transmission portion and a frequency of transmission from the transmission portion;
a host vehicle speed detection portion that detects a speed of the host vehicle; and
a deceleration determination portion that determines whether the host vehicle decelerates or predicts whether the host vehicle will decelerate,
wherein in a case where the deceleration determination portion determines that the host vehicle decelerates or predicts that the host vehicle will decelerate, the transmission control portion controls the at least one of the transmission output and the frequency of transmission so that the at least one of the transmission output and the frequency of transmission is equal to a first value higher than a second value at a time point at which the deceleration determination portion determines that the host vehicle decelerates or predicts that the host vehicle will decelerate.

11. The vehicle communication system according to claim 10, wherein
the transmission control portion maintains the at least one of the transmission output and the frequency of transmission at the first value during a predetermined period.

12. A vehicle communication system comprising:
a transmission portion which is provided in a host vehicle, and which transmits information;
a host vehicle speed detection portion that detects a speed of the host vehicle;
a deceleration determination portion that determines whether the host vehicle decelerates or predicts whether the host vehicle will decelerate; and
a transmission control portion that executes a vehicle speed-dependent control that controls at least one of a transmission output of the transmission portion and a frequency of transmission from the transmission portion according to the speed of the host vehicle detected by the host vehicle speed detection portion so that the at least one of the transmission output and the frequency of transmission is set to a lower value as the speed of the host vehicle detected by the host vehicle speed detection portion becomes lower,
wherein in a case where the deceleration determination portion determines that the host vehicle decelerates or predicts that the host vehicle will decelerate, the transmission control portion delays start of the vehicle speed-dependent control.

13. The vehicle communication system according to claim 12, wherein
the transmission control portion executes a vehicle speed-independent control that sets the at least one of the transmission output and the frequency of transmission to a value that is equal to or higher than a value at a time point at which the deceleration determination portion determines that the host vehicle decelerates or predicts that the host vehicle will decelerate, independently of the speed of the host vehicle, during a period for which the start of the vehicle speed-dependent control is delayed.

14. A vehicle communication method comprising:
transmitting information stored in a host vehicle;
detecting a speed of the host vehicle;
setting at least one of a transmission output at which the information is transmitted and a frequency of transmission with which the information is transmitted, according to the detected speed of the host vehicle so that the at least one of the transmission output and the frequency of transmission is set to a lower value as the speed of the host vehicle becomes lower;
determining whether the host vehicle decelerates or predicting whether the host vehicle will decelerate; and
controlling the at least one of the transmission output and the frequency of transmission so that the at least one of the transmission output and the frequency of transmission is high in a case where it is determined that the host vehicle decelerates or it is predicted that the host vehicle will decelerate, as compared to a case where it is determined that the host vehicle does not decelerate or it is predicted that the host vehicle will not decelerate.

15. A vehicle communication method comprising:
transmitting information stored in a host vehicle at a transmission output and with a frequency of transmission;
detecting a speed of the host vehicle;
determining whether the host vehicle decelerates or predicting whether the host vehicle will decelerate; and
setting at least one of the transmission output and the frequency of transmission to a value higher than a value at a time point at which it is determined that the host vehicle decelerates or it is predicted that the host vehicle will decelerate, in a case where it is determined that the host vehicle decelerates or it is predicted that the host vehicle will decelerate.

16. A vehicle communication method comprising:
transmitting information stored in a host vehicle;
detecting a speed of the host vehicle; and
executing a vehicle speed-dependent control that controls at least one of a transmission output at which the information is transmitted and a frequency of transmission with which the information is transmitted, according to the detected speed of the host vehicle so that the at least one of the transmission output and the frequency of transmission is set to a lower value as the speed of the host vehicle becomes lower;
determining whether the host vehicle decelerates or predicting whether the host vehicle will decelerate; and
delaying start of the vehicle speed-dependent control, in a case where it is determined that the host vehicle decelerates or it is predicted that the host vehicle will decelerate.

17. The vehicle communication method according to claim 16, further comprising:
executing a vehicle speed-independent control that sets the at least one of the transmission output and the frequency of transmission to a value that is equal to or higher than a value at a time point when it is determined that the host vehicle decelerates or it is predicted that the host vehicle will decelerate, independently of the speed of the host vehicle, during a period for which the start of the vehicle speed-dependent control is delayed.
